(19) United States
(12) Patent Application Publication
(10) Pub. No.: US 2022/0318930 A1
(43) Pub. Date: Oct. 6, 2022

(54) CUSTOMIZED INTEGRATED DATE ORGANIZATION AND PERSONALIZED DATING CALENDAR SYSTEM AND METHOD

(71) Applicants: Billie Jo Prisby, Boca Raton, FL (US); Melissa Gross, Parkland, FL (US)

(72) Inventors: Billie Jo Prisby, Boca Raton, FL (US); Melissa Gross, Parkland, FL (US)

(21) Appl. No.: 17/658,181

(22) Filed: Apr. 6, 2022

Related U.S. Application Data
(60) Provisional application No. 63/200,970, filed on Apr. 6, 2021.

(51) Int. Cl. G06Q 50/00; G06Q 10/10

(52) U.S. Cl. CPC G06Q 50/01; G06Q 10/1095

(57) ABSTRACT

A system, method, apparatus, and computer program product that provides customized, integrated date organization and personalized dating calendar. The present invention, My Little Black Book™, includes a mobile app and server hosted platform that allows dating apps and website users to manage and organize their complicated digital dating life with easy-to-use features including, but not limited to schedule management, knowledge of dating partners, ratings, and historical summary, all in an user friendly, interactive and organized way. The system is configured for integration with and extraction of a user's dating information from multiple dating platforms for consolidation in a single app. Other aspects may include integrations with ticketing platforms for events, restaurant reservations, and other services contributing to facilitating date scheduling.

This application claims the benefit of priority of U.S. provisional application No. 63/200,970, filed Apr. 6, 2021, the contents of which are herein incorporated by reference.

### BACKGROUND OF THE INVENTION

The present invention relates to computer implemented methods, and more particularly to a computer implemented customized, integrated date organization and personalized dating bucket and calendar system and method.

Currently, dating sites include no way to integrate all sites on one platform for ease of use and organization. Often users confuse which date came from which site and ultimately could lose out on a potential long-term user. Further, users may receive many unwanted incoming messages which must be individually sorted in an efficient manner.

Users of dating sites consistently complain about being on multiple sites and how they wish there were a better way to view and filter through all dates through all sites. No solution exists which is capable of consolidating dating sites in one location for convenience and efficiency. Online dating is cumbersome and lacks personalization for the user. Users with a busy lifestyle find the lack of organization and efficiency makes the dating world daunting. There is no available integrated system to streamline all dating apps to a one stop shop.

As can be seen, there is a need for improved systems, apparatus, and method to provide simple, efficient, and capable of integrating multiple dating sites in use by a user through a single app and desktop platform.

### SUMMARY OF THE INVENTION

In one aspect of the present invention, a method for date organization across multiple dating sites utilized by a user is disclosed. The method includes extracting, at an online system, a user's dating data from one or more online dating services utilized by the user. The user's dating data includes a contact information for at least one of a dating partner and a potential dating partner. The online system generates a unified repository of the user's dating data. The online system receives, from a user of the online system, a user activation of a new date control. The online system also receives a calendar date selection for a new date from the user. A dating partner selection for the new date is received by the online system from the user. The dating partner selection corresponds with the contact information from the unified repository. The online system receives an entry of one or more alphanumeric characters corresponding to a date location from the user. Responsive to that, the online system generates a list of matching locations corresponding with the entry of the one or more alphanumeric characters. The online system transmits the list of matching locations to the user. The online system then receives a date location selection from the list of matching locations. The online system then generates a scheduled date event, on the online system.

In some embodiments, the method also includes generating, at the online system, the list of matching locations based on a geographic location of the user.

In some embodiments, the online system determines, whether the date location selection requires one or more of a reservation or a ticket purchase. When the date location requires the reservation, the online system links the user with an online reservation system. When the date location requires a ticket purchase, the online system links the user with an online ticketing system.

In some embodiments, the method also includes receiving a user selection of a notification contact for the scheduled date event. The method may also include receiving a user check-in for the scheduled date event. The online system may also transmit a date summary of the scheduled date event to the notification contact. The method may also include receiving a user update for the scheduled date event. Likewise, the online system may transmit the user update to the notification contact.

In some embodiments, the online system also determines a completion of the scheduled date event. The online system may then activate a rate your date control for the user to rate the scheduled date event as a completed date event. The method includes receiving, by the online system, one or more attribute ratings for the completed date event from the user. At least one of the one or more attribute ratings correspond to an attribute rating of the dating partner. Similarly, at least one of the one or more attribute ratings correspond to an attribute rating of the date location.

In other embodiments, the method includes ranking the completed date event against one or more other completed date events, by the online system, based on the one or more attribute ratings. The method may also include, generating, by the online system, a leaderboard, reflecting a ranking of each of the one or more completed date events based on the one or more attribute ratings.

These and other features, aspects and advantages of the present invention will become better understood with reference to the following drawings, description and claims.

### BRIEF DESCRIPTION OF THE DRAWINGS

FIG. 1 is a representative system architecture for the integrated date organization and personalized dating calendar, My Little Black Book™.

FIG. 2 is a representative method of utilizing the integrated date organization and personalized dating calendar, My Little Black Book™

FIG. 3 is a representative user interface (UI) for setting up a user profile.

FIG. 4 is a representative UI for adding a new contact.

FIG. 5 is a representative UI for filtering contacts.

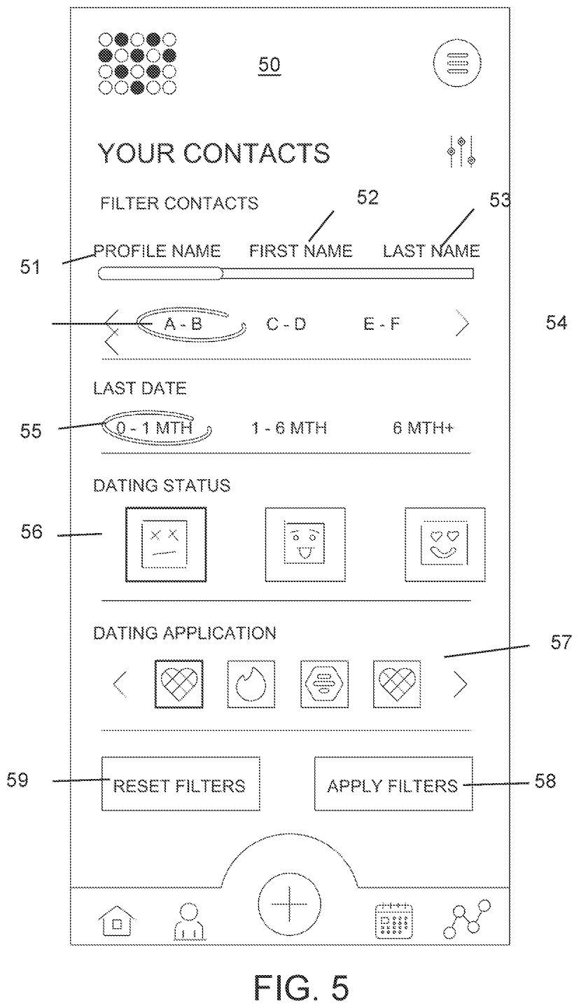

FIG. 6 is a representative UI for a list contacts view.

FIG. 7 is a representative UI for adding a new date.

FIG. 8 is a representative UI for a date summary continuing the new date UI of FIG. 7.

FIG. 9 is a representative UI for a date location selector.

FIG. 10 is a representative UI for a restaurant booking agent.

FIG. 11 is a continuation of the new date UI of FIG. 8.

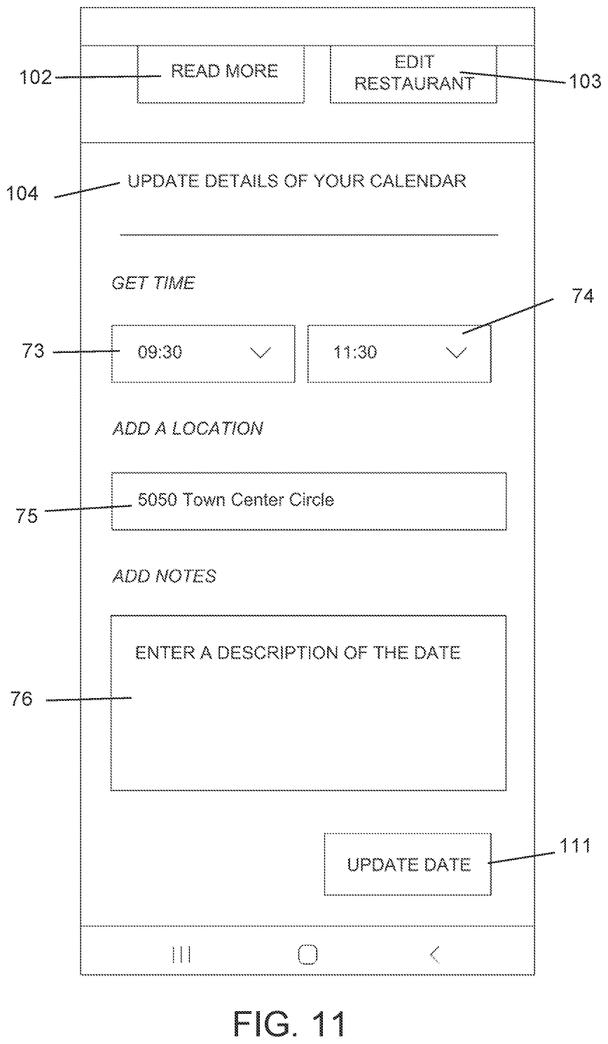

FIG. 12 is a representative UI for a date details page. FIG. 13 is a representative UI for a digital date calendar view.

FIG. 13 is a representative UI for a list view of a list view of upcoming dates.

FIG. 14 is a representative US for a date detail view.

FIG. 15 is a representative UI for a date safety feature.

FIG. 16 is a representative UI for a detailed date rating

FIG. 17 is a representative UI for a comparative date ranking

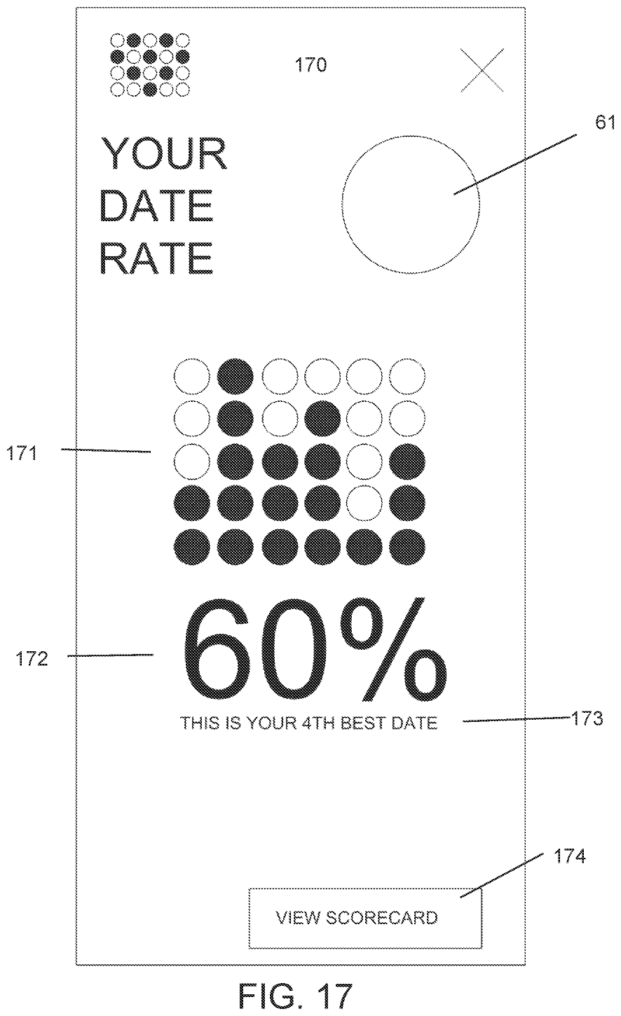

FIG. 18 is a representative UI for a date scoreboard.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provide a system, method, apparatus, and computer program product that provides customized, integrated date organization and personalized dating calendar. The present invention, hereinafter My Little Black Book™, includes a mobile app and server hosted platform that allows dating apps and website users to manage and organize their complicated digital dating life with easy-to-use features including, but not limited to schedule management, knowledge of dating partners, ratings, and historical summary, all in an user friendly, interactive and organized way. The system is configured for integration with and extraction of a user's dating information from multiple dating platforms for consolidation in a single app. Other aspects may include integrations with ticketing platforms for events, restaurant reservations, and other services contributing to facilitating date scheduling.

The My Little Black Book™ system integrates multiple dating sites into one platform making it simple and more efficient, rather than requiring the user to toggle between multiple dating sites. The My Little Black Book™ system achieves a goal of integrating multiple dating sites affiliated with a user, while adding and taking away any of the user's dating apps for customization.

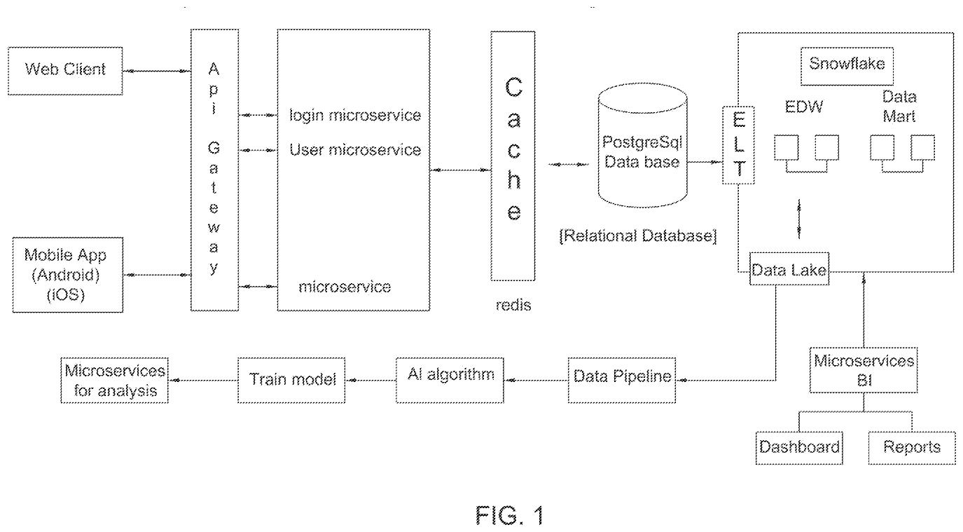

A representative system architecture is shown in reference to FIG. 1. The system may be implemented as a cloud-based service to provide user access via a web client and/or a mobile app operating on Android, iOS, or another operating system. An application program interface (API) Gateway provides for connectivity of users with a server hosting the My Little Black Book™ services. A first microservice is provided for managing user authentication and interactions with the system.

A microservice is provided for managing user authentication and interactions with the system. All end user experiences are driven through the login and user microservices, in conjunction with the API gateway. First-party users of the services utilize the mobile application. Third party consumers of metrics and data analysis utilize the web client, including web page and data-driven API formats.

A cache holds in memory data produced by the user and stored in MLBB's database. On the first request, user data is pulled from the database and saved in the cache, allowing subsequent requests to respond faster.

Users can create date contacts from existing entries in the contact list, as well as enter bespoke entries in manual fashion. Contact data includes, but is not limited to: first/last name, source of the contact (i.e. which dating service provided the initial introduction), a shorthand profile name, dating or eligibility status, and telephone number.

When a user creates a new dating event with an existing contact, the contact is connected with a scheduled event reservation. The contact and reservation data are collectively stored as a scheduled date event. A notes field allows user to enter bespoke details for the event or other person, and the system will provide timed reminders as the date approaches. The MLBB reservation may connect to events identified, purchased, and tracked by third party providers, e.g. Ticketmaster. The MLBB reservation may include geographical data (street address, restaurant location, etc.) supported by third party geographical data providers.

Following the conclusion of a date, the user can rate the date along a series of quality and satisfaction indicators. This information is saved for the users future review, allowing them to visualize trends in their dating habits and those of their dating partners. MLBB also utilizes this data in the Al algorithm training (described in more detail below).

An extraction, load, transformation (ELT) process is configured in which the extraction process is configured to extract the user's dating data from one or more dating services utilized by the user. The user's dating data is then loaded and secured for making the dating data available for integration with the My Little Black Book™ services. The transformation process updates the user's dating data to match My Little Black Book™ services needs and data storage solution requirements. Transformation can involve converting the user's dating data types to the same format, cleansing by removing inconsistent or inaccurate data, combining data elements from multiple data models, pulling in data from other sources, and other processes. During transformation, rules and functions are applied and data cleansed to prevent including bad or non-matching data to the destination repository. The ELT sequence allows My Little Black Book™ to preload a user's raw dating data to a unified repository, such as an enterprise data warehouse (EDW) where it can be modified.

The Enterprise Data Warehouse (EDW) is provided as a relational data warehouse containing the user's consolidated dating data, including information about the user's dating history. The Data Marketplace provides third parties access to information that is generated through the data collected about users through their interaction with the system. This data is further processed by means of algorithms that leverage mechanisms such as augmented analytics, machine learning and Artificial Intelligence to provide insights into user preferences, behaviors and propensities. Information supplied by the marketplace by means of proprietary data structures and schema defined by MLBB.

A Data Lake stores large volumes of structured, semi-structured, and unstructured data in its native format. MLBB utilizes Data Lake technology to collect detailed metrics regarding user activity within the application, including all user-facing date-scheduling functionality, as well as timestamped logging of activity within the application, e.g. opening/closing the app, modifying dates, adding/removing contacts.

A Data Pipeline continuously delivers metrics from the data lake to the Al algorithm in order to train and produce predictive services for users. On a set interval—based on data size or time lapsed—the pipeline will provide fresh data to the AI algorithm in order to Train a new machine learning model. Data provided to the model is made up of user-entered data and user activity logs collected by the application on the user's device. The pipeline ensures the data is delivered and stored in the data lake for later retrieval and further analysis. The AI algorithm continuously updates a Training Model based on new incoming user data to the data lake.

Output of the Training Model is provided to one or more microservices within the application, to be consumed by users on their device. These microservices may be configured to provide recommendations and other predictive insights to the user, based on their actions and collective actions of all platform users.

A Business Intelligence (BI) microservice is configured to provide dashboards and reports. Dashboards and reports are a means of projecting the information stored in the MLBB data lake. These dashboards and reports are consumed by MLBB users, third parties and MLBB system administrators. The reports and dashboards provides each consumer a specialized view into information germane for their specific needs. Information supplied by the dashboards and reports by means of proprietary data structures, schema and algorithms defined by MLBB. Data displayed on the dashboards includes metrics directly from the corpus of information within the data lake, as well as analysis output from the Al algorithm training models.

The ordered combination of various ad hoc and automated tasks in the presently disclosed platform necessarily achieves technological improvements through the specific processes described more in detail below. In addition, the unconventional and unique aspects of these specific automation processes represent a sharp contrast to merely providing a well-known or routine environment for performing a manual or mental task.

The customized integrated date organization and personalized dating calendar system, My Little Black Book™ system is designed to and functions to integrate multiple dating sites affiliated with the user while adding and taking away any of a user's dating apps for customization. My Little Black Book™ system offers individualized dating filters via an inventive bucket system throughout the platform and organization with a personalized dating calendar on the My Little Black Book™ integrated app.

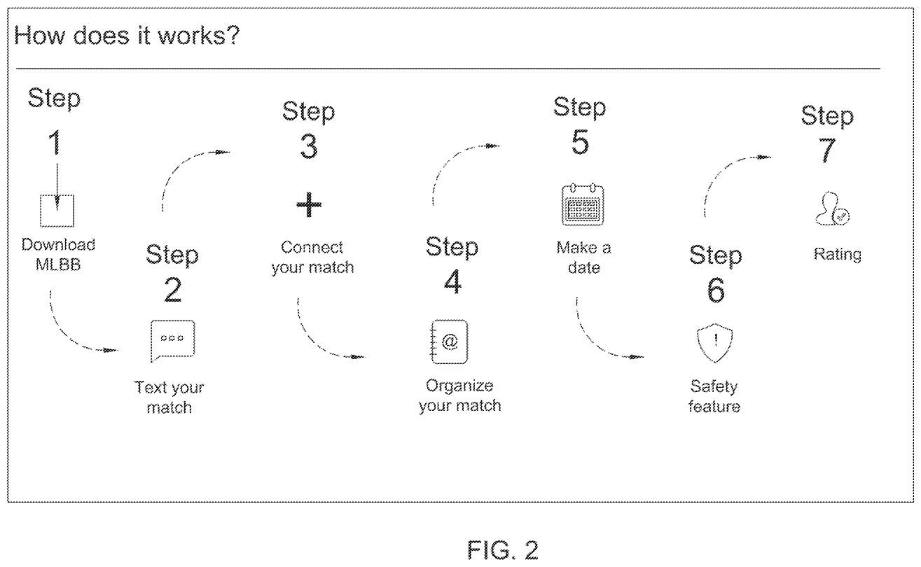

A representative method of utilizing the My Little Black Book™ system is depicted in FIG. 2. In a first step, the user may download the My Little Black Book™ app to their mobile device. In a second step, the user may communicate with a match (potential date), such as via a text message utilizing the native function of the mobile computing device. The user then connects the match from the text message and auto populates contact information from the native contacts list of the user's mobile computing device into the MLBB app and message for notes.

A fourth step allows the user to organize their matches. The user may organize their matches in the MLBB by one or more sources, such as by a native dating app, a social media app, an out an about option, and a dating status bucket rating.

In a fifth step, the user may make a date utilizing the digital integrated calendar feature. The digital integrated calendar feature which provides the user a straightforward way to organize upcoming dates by dating site and calendar date. This feature provides users the ability to pick one or more of a calendar date, a meeting time, a location, information concerning their connections, while adding a note to the date and picking a time that they will be meeting. The digital integrated calendar feature may also include a geo tracking icon where a user may click and make an online date reservation via a reservation scheduling system, such as the Open Table feature. The user may then send the reservation confirmation to the upcoming date.

Next, the user may specify one or more safety features. Users have control of their safety by adding as one or more safety contacts to their profile and sending a detailed text of their date parameters, such as who they will be going on a date with, what activity will they be engaging in on a date, a calendar date and time for the date, a location for the date, and an expected duration for the date. will be gone complete with end of date check out.

In a last step, the system may provide the user a post date rating system for the user to assess the date according to one or more parameters. The one or more parameters may include the dating app, traits of the date, an atmosphere for the date. The rating may include a notes section for detailing one or more date highlights, to serve as a reminder of the date. The post date rating system with leaderboard to track dates by app, traits, and atmosphere with notes for a reminder of date highlights.

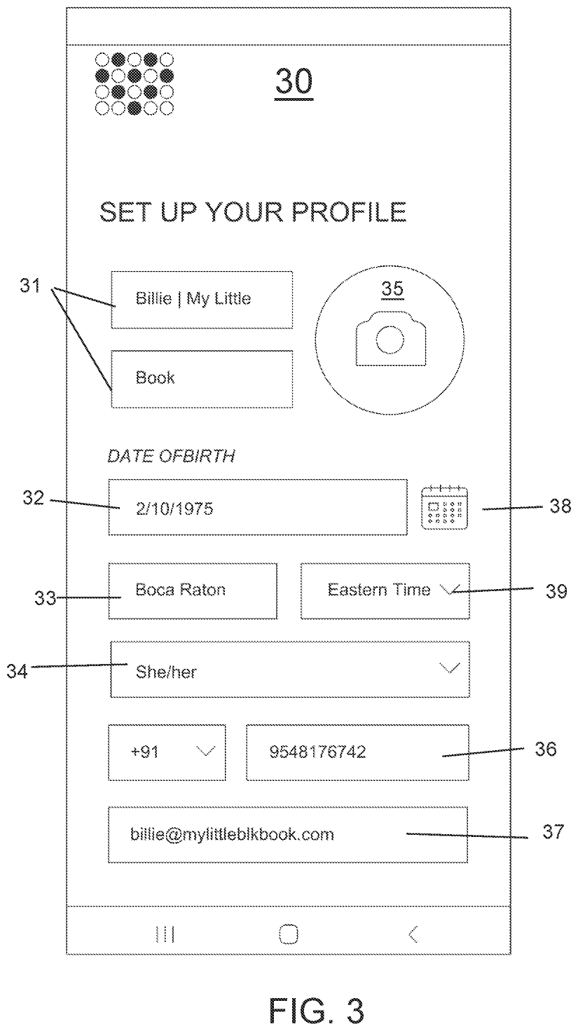

Once the user has downloaded and launched the app, the app launches a user interface (UI), such as shown in FIG. 3 to assist them in establishing a user profile. The user profile UI 30 includes identification information and contact information of the user. The identification information may be utilized by the service provider for authentication of the user's account. The contact information is utilized for exchanging messages or communications with a prospective date or one or more contacts that the user has incorporated into the app.

The identification information may include the user's name 31, date of birth 32, a location 33, a preferred pronoun 34. The identification information may also include a profile photo 35 of the user. The app may be configured to auto populate a profile photo from one or more social media sites, such as Facebook, Google, or manuell. The contact information may include a telephone number 36 and an e-mail address 37, each of which may also be utilized as identification information to authenticate the user with the system. The profile setup UI 10 may also include one or more controls, such as a calendar control 38, for selecting their date of birth. A geo lookup functionality may be provided for entry of the user's location 33. Likewise, a time zone selector control 39 may be provided for selecting a desired time zone. The time zone selector 39 may be linked with the geo lookup to provide a correct time zone and accommodate for daylight savings time and standard time, based on the user's location 33 and the calendar date. A preferred pronoun selection control 39 may be provided for selecting a desired pronoun the user identifies with.

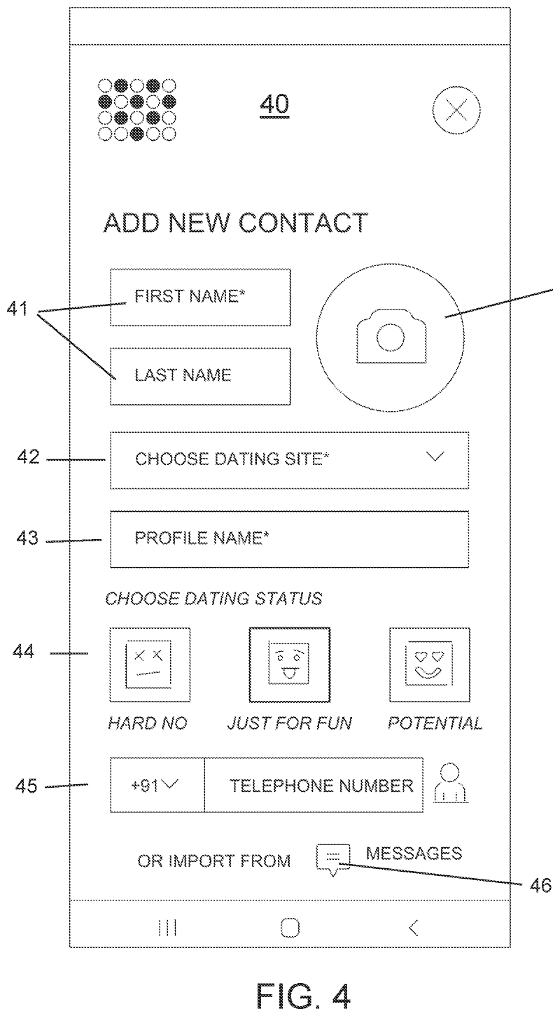

FIG. 4 depicts 4 is a representative new contact UI 40 for adding a new contact. The new contact UI 40 includes a space for a contact name 41, a control for selecting a source dating site control 42 for selecting or designating a dating site where the contact originated with. A contact profile name 42, which may correspond with a user and/or a profile name 43 of the contact on the selected dating site. A dating status bucket icon 44 includes a display of one or more dating status icons presenting a visual depiction of the contact's dating status. The dating status bucket icon 44 may be based on a designation selected by the user in assessing the dating prospects of the contact. A contact telephone number 45 may be manually entered by the user or may be imported from a native text messaging application of the user's mobile computing device, via activation of an import control 45. The contact UI 40 may also include a profile picture 46 of the contact, which may be imported from the source dating site to facilitate corresponding the contact with their image on the source dating site.

My Little Black Book™ system provides a new seamless way to filter out and organize the user's complicated dating life. This inventive platform has a screening section with multiple filters such as, for example without limitation, age, race, religion, physical appearance, activity, location, interests, or the like. The multipole filters enable the users to narrow their search to only what they desire. The app may also be configured with a contact filtering UI 50 for setting one or more filters for selecting or locating a contact. The contacts filtering UI 50 includes one or more user selectable filters including a profile name filter 51, a first name filter 52, a last name filter 53. An alpha range filter 54 allows the user to further filter one or more of the profile name filter 51, the first name filter 52, and the last name filter 53, via a selected range of letters in the alphabet. Contacts may also be filtered based on a last date filter 55 based on a recency of the user having a date with the contact. The contacts filtering UI 50 also incorporates a dating status bucket 56 and a source dating site filter 57. The user may set one or more of the filters and activate an apply filter control 58 to activate the one or more set filters and facilitate locating the contact based on the one or more set filters. A reset filter control 59 is provided to clear the filters from the contacts filtering UI 50. By streaming and utilizing the filters, the system alleviates the frustration of unwanted incoming messages by utilizing the inventive dating status bucket system.

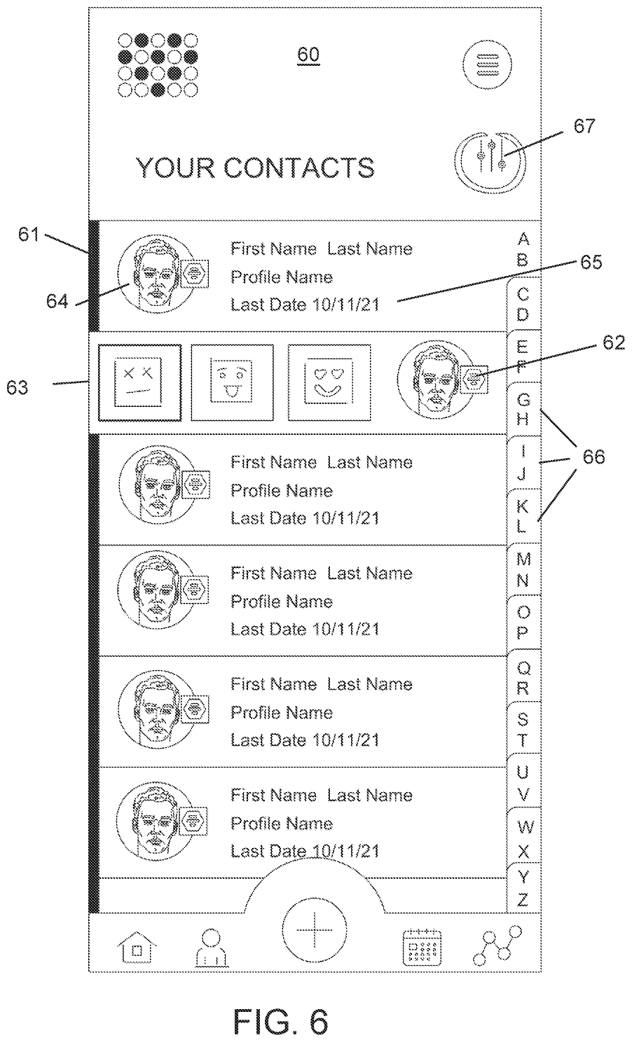

FIG. 6 illustrates a representative contacts list view UI 60 which opens responsive to the user selected settings in the contacts filtering UI 60. One or more contacts meeting the filter settings are presented in the list view. The filtered contacts are presented in a contact summary 61, which may include the various filter criteria that the contact matches. For example, the contact summary may include a dating site icon 62, the dating status bucket icon 63, and the contact's profile picture 64, and a last date 65. The contacts list view UI 60 may also include alphabetic tab controls 66, similar to a conventional address book. Each of the filter UIs 50, 62, may include a filter view control 67, that is user selectable to sort the list based on the contact's name, the contact profile name, the dating status bucket icon, or the dating app/social media app they are associated with.

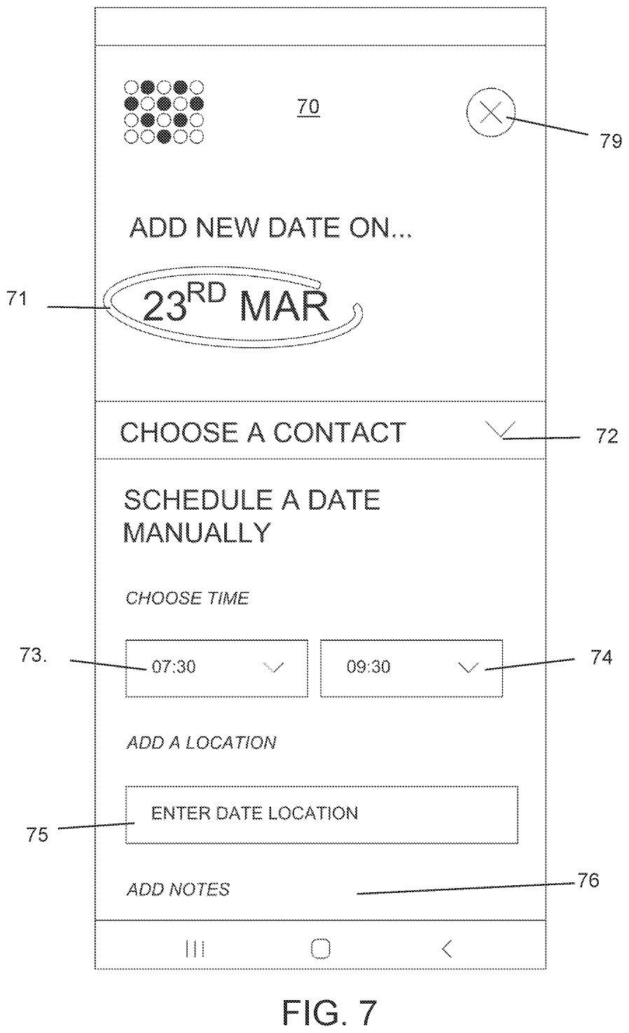

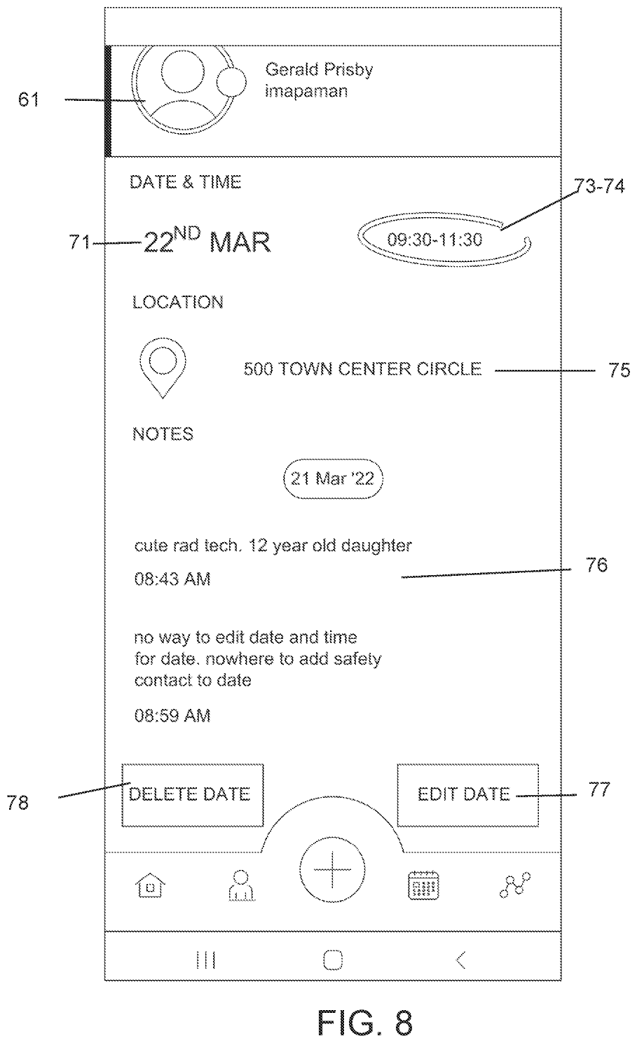

A new date UI 70 is shown in reference to FIG. 7. The new date UI 70 includes controls for selecting a calendar date 71, a dating partner 72, a date start time 73, a date stop time 74, a date location 75, and may include a notes area for recording information pertaining to the date. The new date UI 70 may include a manual entry of the calendar date 71. As each of the new date UI 70 controls are activated, the date information is progressively populated in the new date UI 70. Once populated the new date UI corresponds with the planned date UI 80, shown in reference to FIG. 8.

The calendar date 71 may be manually entered or may be selected via a calendar control. The calendar date 71 may be initially presented as the current calendar date. The dating partner control 72 may include a drop-down list displaying all of the user's contacts. More preferably, the dating partner control 72 is populated with the user's contacts filtered according to the one or more filters selected in the contacts filtering UI 50. Once the dating partner control 72 is operated to select the dating partner, the abbreviated profile information, similar to that of the contact summary 61 shown in the filter list view UI 60 is presented in the new date UI 70. The date start time 73 and the date stop time 74 may be manually entered or be selected via a time selector wheel, or a drop down. A cancel control 79 may be activated to cancel the new date at any time in the sequence.

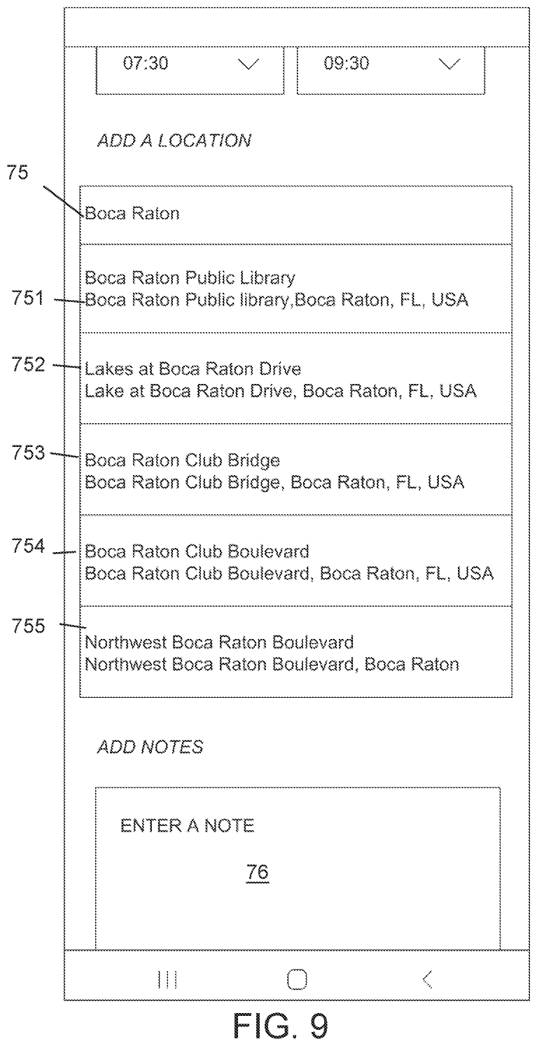

The date location 75 may be active with a geolocation service of the user's mobile computing device. As the user types an entry for the date location, the geolocation service identifies venues 751-755, such as parks, restaurants, museums, attractions, sporting events, landmarks, and the like, as potential locations for the date, such as shown in reference to the expansion of the date location 75 control operation as seen in FIG. 9. Once selected, the date location 75 is incorporated into the new date UI 70.

Notes 76 about the date partner or the planned date may be incorporated in a notes field 76. The order and sequencing of operating the controls in the new date UI 70 can be approached in any manner. For example, the user may want to go with a certain date partner, in which case, there may be certain date locations or activities that the date partner would like or dislike. Similarly, the user may wish to go on a date to a certain date location, in which case, the selection of a date partner may be based on the selected certain date location.

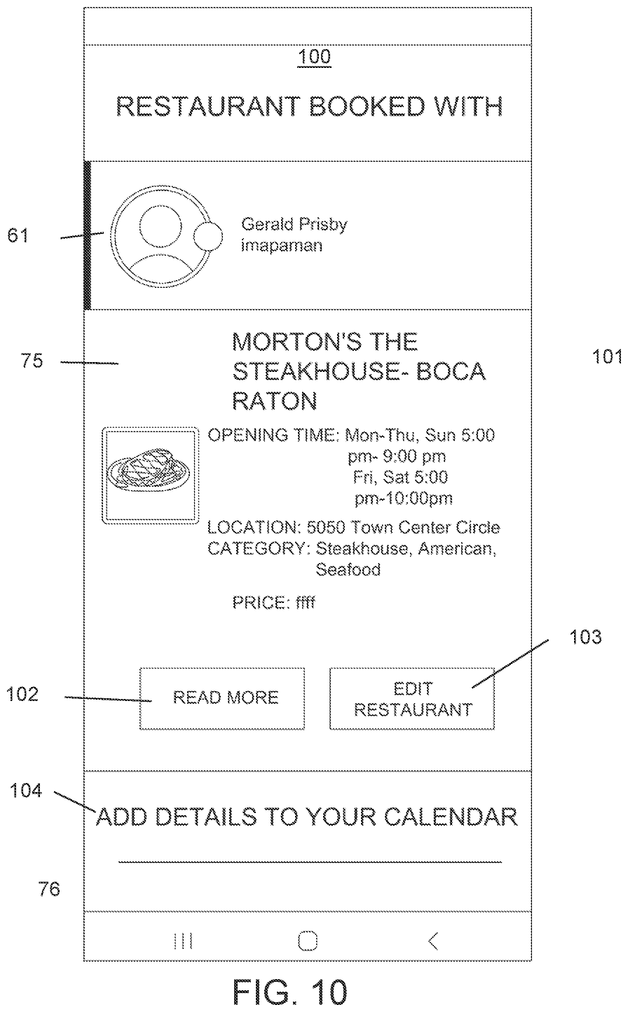

When the system detects that a selected date location 75 corresponds with a venue or an event for which one or more of a reservation or a ticket are required, the app may launch a booking agent 100, such as shown in reference to FIG. 10. By way of non-limiting example, if the selected date location is a restaurant, the server is configured to integrate with a restaurant reservation system, such as Open Table or other reservation system affiliated with the selected restaurant.

To facilitate placing the reservation with the selected restaurant 101, and or reservation service, the system is configured to prepopulate the data entry fields for the reservation service with the information that has been specified for the date. Once the reservation is confirmed, details 101 about the venue may be presented, such as name, logos, operating hours, location, and the like. A read more control 102 may be provided for a more in-depth description of the date location 75, such as a menu or specials for the selected calendar date 71 and time 73-74. An add details to your calendar control 104 may be provided to incorporate the date location details with the native calendar application for the user's mobile computing device OS. An edit restaurant control 103 allows the user to select another date location.

When the user has entered or partially entered information pertaining to the new date, the user may enter and update date control 111 to save information that has been entered, updated, or changed. As will be appreciated, since the planning of a date can rely on many variables as to time, location, availability, and the like. Accordingly, the new date UI 70 may be revisited as the user develops additional information relevant to the date.

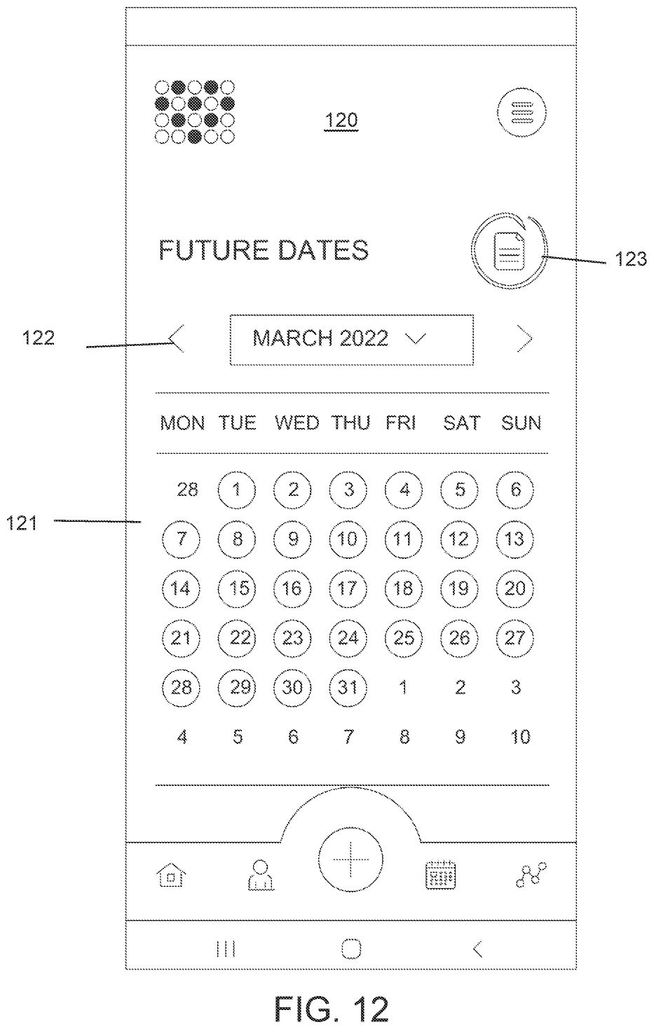

A digital integrated calendar UI 120 is shown in reference to FIG. 12. The digital integrated calendar UI 120 may present the user with a schedule of future dates on in a calendar format.

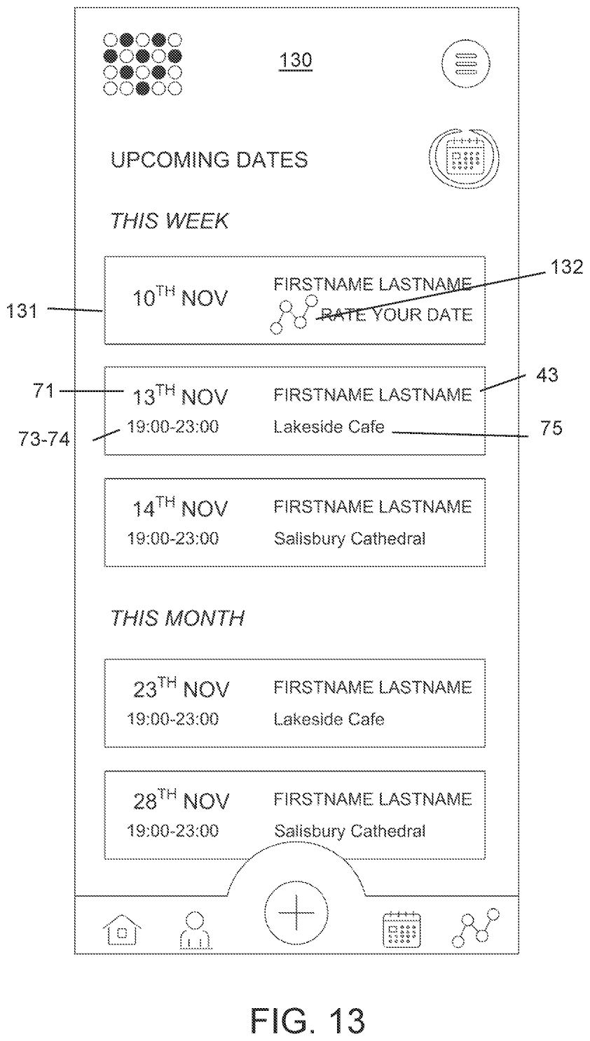

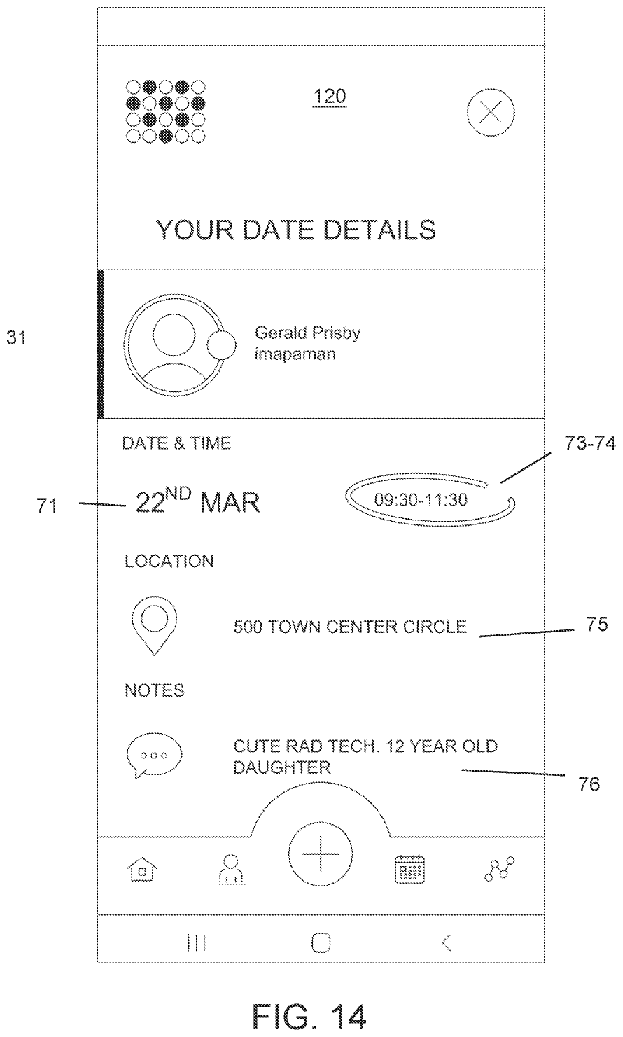

The My Little Black Book™ system includes a digital integrated calendar feature provides an easy way for a user to organize upcoming dates by site, date and bucket choice. This feature allows the users to pick and place their connections information while adding a note to the date and pick the time that they will be meeting. Future dates may be represented by an indicator, such as a circle, highlight, shading, or the like for a date on a calendar representation 121. One or more calendar range controls 122 are provided for selecting a desired calendar for display in the digital integrated calendar UI 120. Activation of a selected day from the calendar representation will open a date details summary, such as shown in reference to FIG. 14. The calendar UI 120 may also include a list display control 123, activation of which may present the user's upcoming dates in a list display UI 130, such as shown in FIG. 13.

The list display UI 130 presents a sequential listing of the user's planned dates and a summary 131 of each date. The date summary 131 may include the calendar date of the event 132, the contact's name of the date partner 43 for the date, the location 75, the start time 73, and the projected end time. The user's dates may be presented by week, month, or another temporal period. If the system determines that a calendar date 71 and/or end time 74 for the scheduled date has passed, the summary 131 may be populated with a rate your date control 132, activation of which permits the user to rate the overall date, as well as the date partner 43, as discussed further below. Activation of a selected summary 131 may open the selected in one of a date details UI 140, shown in FIG. 14, or allow for editing of the date through the new date UI 70, options for which may be specified in an app settings area.

Each of the respective UIs may also include multiple navigational controls for moving the user through the various UIs and features of the app. The multiple navigational controls are also depicted in FIG. 14. The multiple navigational controls may include a home control 141, a contacts control 142, a calendar control 143, a ratings control 144, and an add date event or contact control 145. Activation of the home control 141 navigates the user to the home screen. Activation of the contacts control 142 presents the contacts UI 60. Activation of the calendar control presents the calendar interface UI 120. Selection of the ratings control 144 launches a date rating and leaderboard, as discussed further below. Selection of the add control 145 may prompt the user whether they would like to add a new contact or a new date. The add control 145 may also be linked with the particular UI that the user is viewing at the time. For example, when the user is in the calendar interface UI 120, activation of the add button will default to launching the new date UI 70. Likewise, when the user is in the contacts UI, activation of the add button will launch the add contact UI 40.

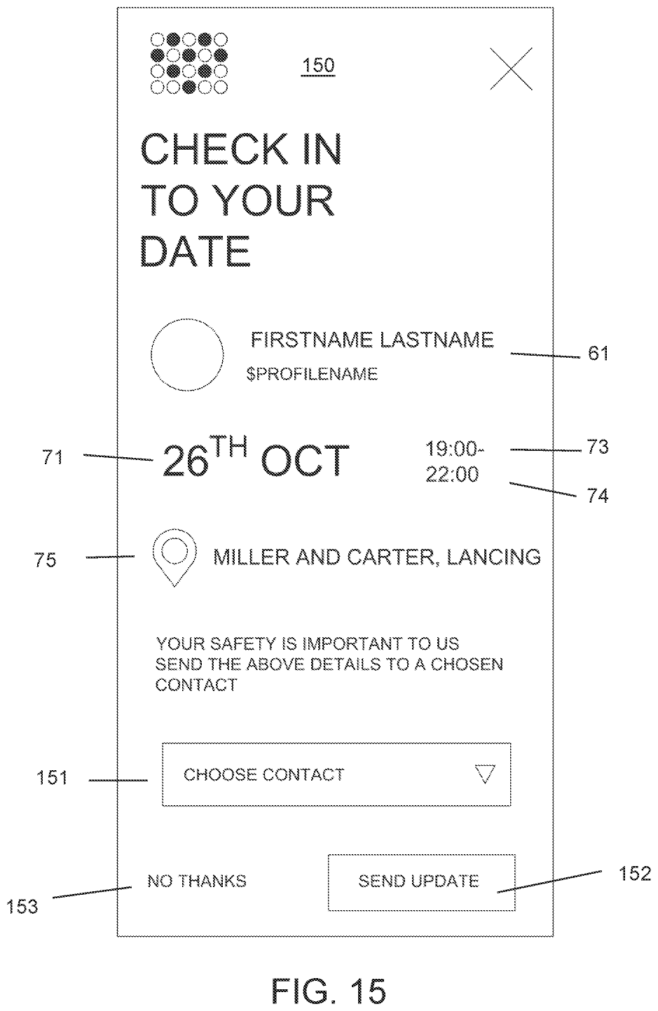

As shown in FIG. 15, the user may implement safety features by sharing their date information with a notification contact through a date check in UI 150. The notification contact may be selected by activation of a notification contact control 151. The date check in UI 150 includes a contact summary 61 for their date partner on the dating event. The calendar date 71, start time 73 and anticipated end time 74, and location 75 may be presented. The date check in UI 150 may automatically be activated when the scheduled date 71 and start time 73 are reached, allowing the user to select one or more contacts to notify of the date details. A send update control 152 allows the user to manually check in for the date with the system and the one or more notification contacts. The send update control 152 may be utilized during the scheduled date event or at the completion of the date event. The send update control 152 may be provisioned to allow the user to include a message with an update to the one or more notification contacts. An opt out control 153 may also be provided if the user does not want to check in for the date.

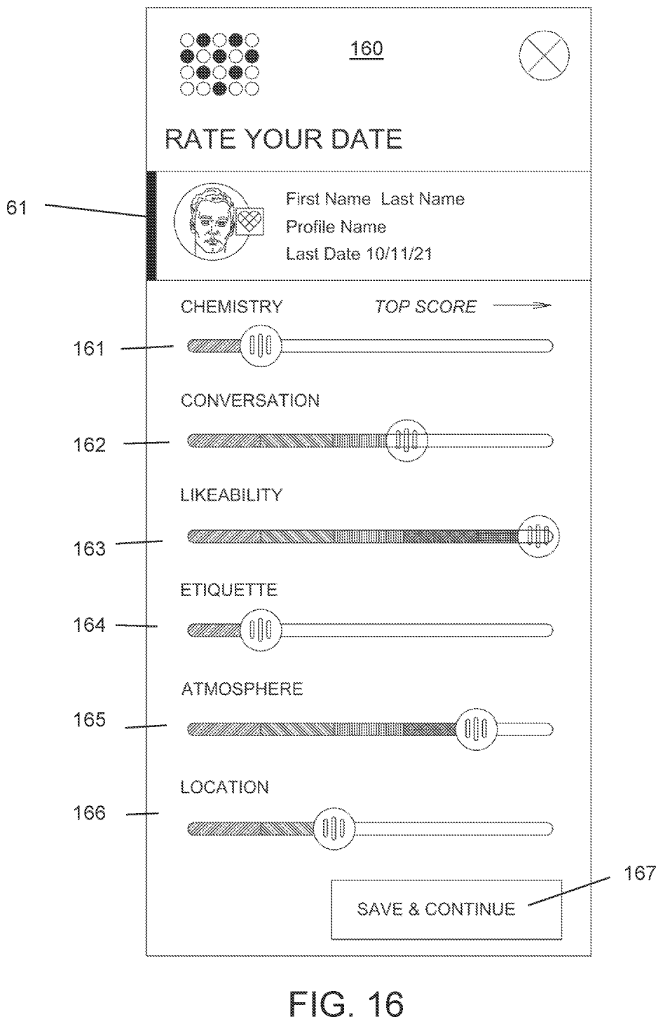

Activation of one of the rate date controls 132, 144 allows the user to rate a dating event and/or the dating partner. A rate your date UI 160 is shown in FIG. 16. The rate you date UI 160 includes multiple controls for rating one or more attributes or characteristics of the date partner and the date event. By way of example, the one or more date partner attributes may include a chemistry 161, a conversation 162, a likeability 163, and an etiquette rating 164. The date event ratings may include an atmosphere control 165 and a location control 166. In the non-limiting embodiment shown, the one or more attribute controls 161-166 may be implemented as a slider indicating a relative rating from a lowest to a highest rating. The slider may be color coded as the user progresses from the lowest rating to the highest rating. When the user has completed entering their ratings, the user may activate a save and continue control 167.

Activation of the save and continue control 167 launches a rating summary

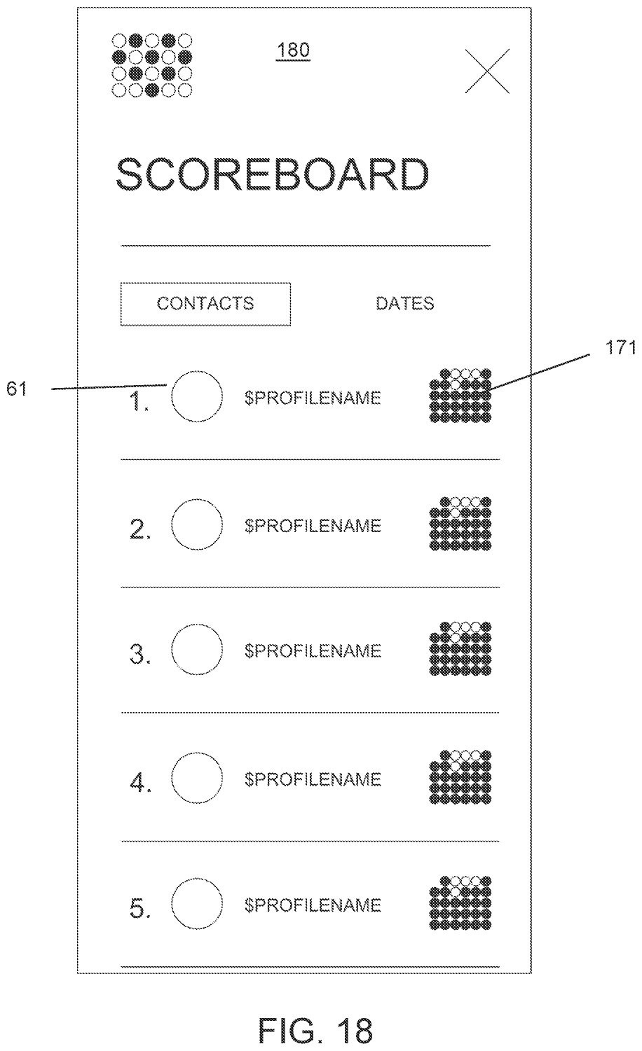

UI 170 that presents a rating summary of the date event and date partner. If the user has previous ratings, the date event will be scored relative to other date events that the user has rated. The rating summary UI 170 may include a profile picture 61 of the date partner. A histogram chart 171, such as the bubble chart, presents the users rating on each of the one or more attributes entered in the rate your date UI 160. A quantified rating 172, such as a percentage, may be presented consolidating the attribute ratings for the date event. A date ranking 173 may also be presented rating the date event against all other rated dates the user has completed. A view scorecard control 174 may be provided to allow the user to view the date event relative to other dating events in a scoreboard UI 180, such as shown in FIG. 18.

As seen in FIG. 18, the scoreboard UI 180 presents a leaderboard for the dating events and dating partners the user has rated. In the non-limiting embodiment shown, the leaderboard may present a ranking of the user's date events. Each date event 181 in the scoreboard UI 180 may include selected profile summary information 61 of the date partner. The histogram chart 171 of the rating for each date event on the leaderboard may be presented with the profile summary information. The user may specify one or more filters, such as by selected contacts 181, calendar dates 182, or one or more other filters, as described previously. The scoreboard UI 180 allows the user to scroll through each date event.

As may be seen in the foregoing descriptions, the My Little Black Book™ system differs from and distinguishes over current solutions. No system exists which is an integrated system to streamline all dating apps to a one stop shop. Users currently must contend with much toggling back and forth between several dating sites, not on one platform. Most users that date are on multiple sites, not just one. The My Little Black Book™ system provides a needed solution which integrates multiple dating sites affiliated while adding and taking away any of dating apps for customization

The system of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like,

The ordered combination of various ad hoc and automated tasks in the presently disclosed platform necessarily achieve technological improvements through the specific processes described more in detail below. In addition, the unconventional and unique aspects of these specific automation processes represent a sharp contrast to merely providing a well-known or routine environment for performing a manual or mental task.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method comprising:
extracting, at an online system, a user's dating data from one or more online dating services utilized by the user, the user's dating data including a contact information for at least one of a dating partner and a potential dating partner;
generating, at the online system, a unified repository of the user's dating data;
receiving, at the online system, from a user of the online system, a user activation of a new date control;
receiving, at the online system, a calendar date selection for a new date from the user;
receiving, at the online system, a dating partner selection for the new date from the user, the dating partner selection corresponding with the contact information from the unified repository;
receiving, at the online system, from the user, an entry of one or more alphanumeric characters corresponding to a date location;
generating, at the online system, a list of matching locations corresponding with the entry of the one or more alphanumeric characters;
transmitting, from the online system, the list of matching locations to the user;
receiving, at the online system, from the user, a date location selection from the list of matching locations; and
generating a scheduled date event, on the online system.

2. The method of claim 1, further comprising:
generating, at the online system the list of matching locations based on a geographic location of the user.

3. The method of claim 1, further comprising:
determining, at the online system, whether the date location selection requires one or more of a reservation or a ticket purchase.

4. The method of claim 3, further comprising:
when the date location requires the reservation, linking, by the online system, the user with an online reservation system.

5. The method of claim 3, further comprising:
when the date location requires the ticket purchase, linking, by the online system the user with an online ticketing system.

6. The method of claim 1, further comprising:
receiving, at the online system, a user selection of a notification contact for the scheduled date event.

7. The method of claim 6, further comprising;
receiving, at the online system, a user check-in for the scheduled date event.

8. The method of claim 7, further comprising:
transmitting, by the online system, a date summary of the scheduled date event to the notification contact.

9. The method of claim 8, further comprising:
receiving, at the online system, a user update for the scheduled date event.

10. The method of claim 9, further comprising:
transmitting, by the online system, the user update to the notification contact.

11. The method of claim 1, further comprising:
determining, by the online system, a completion of the scheduled date event;
activating, by the online system, a rate your date control for the user to rate the scheduled date event as a completed date event;
receiving, by the online system, one or more attribute ratings for the completed date event from the user.

12. The method of claim 11, wherein at least one of the one or more attribute ratings correspond to an attribute rating of the dating partner.

13. The method of claim 12, wherein at least one of the one or more attribute ratings correspond to an attribute rating of the date location.

14. The method of claim 11, further comprising:
ranking, by the online system, the completed date event against one or more other completed date events based on the one or more attribute ratings.

15. The method of claim 14, further comprising:
generating, by the online system, a leaderboard, reflecting a ranking of each of the one or more completed date events based on the one or more attribute ratings.
